(19) United States
(12) Patent Application Publication
(10) Pub. No.: US 2005/0190921 A1
(43) Pub. Date: Sep. 1, 2005

(54) Systems and methods for framing quantum cryptographic links

(75) Inventors: John D. Schlafer, Wayland, MA (US); Oleksiy Pikalo, Belmont, MA (US); Brig B. Elliott, Arlington, MA (US)

Correspondence Address: FISH & NEAVE IP GROUP;ROPES & GRAY LLP, ONE INTERNATIONAL PLACE, BOSTON, MA, 02110-2624, US

(73) Assignee: BBNT Solutions LLC, Cambridge, MA (US)

(21) Appl. No.: 10/985,631

(22) Filed: Nov. 10, 2004

Related U.S. Application Data
(63) Continuation-in-part of application No. 10/271,103, filed on Oct. 15, 2002.
(60) Provisional application No. 60/519,058, filed on Nov. 10, 2003.

(51) Int. Cl. H04L 9/00

(52) U.S. Cl. 380/278; 380/256

(57) ABSTRACT

An optical transmitter includes a transmitting unit and a processing unit. The transmitting unit transmits multiple optical synchronization pulses at a first intensity, and transmits multiple optical quantum cryptographic key distribution (QKD) pulses at a second intensity. The processing unit encodes a cryptographic key symbol in a quantum state of each QKD pulse of the QKD pulses, and delays transmission of each of the multiple optical synchronization pulses a derived interval after transmission of a corresponding one of the multiple QKD pulses.

### CROSS REFERENCE TO RELATED APPLICATIONS

The instant application claims priority from provisional application No. 60/519,058 (Attorney Docket No. 03-4061PRO1), filed Nov. 10, 2003, the disclosure of which is incorporated by reference herein in its entirety.

The present application is a continuation-in-part of U.S. application Ser. No. 10/271,103 (Attorney Docket No. 02-4011), entitled “Systems and Methods for Framing Quantum Cryptographic Links” and filed Oct. 15, 2002, the disclosure of which is incorporated by reference herein in its entirety.

### GOVERNMENT CONTRACT

The U.S. Government has a paid-up license in this invention and the right in limited circumstances to require the patent owner to license others on reasonable terms as provided for by the terms of Contract No. F30602-01-C-0170, awarded by the Defense Advanced Research Project Agency (DARPA).

### FIELD OF THE INVENTION

The present invention relates generally to cryptographic systems and, more particularly, to quantum cryptographic systems.

### BACKGROUND OF THE INVENTION

Within the field of cryptography, it is well recognized that the strength of any cryptographic system depends on, among other things, the key distribution technique employed. For conventional encryption to be effective, such as a symmetric key system, two communicating parties must share the same key and that key must be protected from access by others. The key must, therefore, be distributed to each of the parties. FIG. 1 shows one form of a conventional key distribution process. As shown in FIG. 1, for a party, Bob, to decrypt ciphertext encrypted by a party, Alice, Alice or a third party must share a copy of the key with Bob. This distribution process can be implemented in a number of conventional ways including the following: 1) Alice can select a key and physically deliver the key to Bob; 2) a third party can select a key and physically deliver the key to Bob; 3) if Alice and Bob both have an encrypted connection to a third party, the third party can deliver a key on the encrypted links to Alice and Bob; 4) if Alice and Bob have previously used an old key, Alice can transmit a new key to Bob by encrypting the new key with the old; and 5) Alice and Bob may agree on a shared key via a one-way mathematical algorithm, such as Diffie-Helman key agreement. All of these distribution methods are vulnerable to interception of the distributed key by an eavesdropper Eve, or by Eve “cracking” the supposedly one-way algorithm. Eve can eavesdrop and intercept or copy a distributed key and then subsequently decrypt any intercepted ciphertext that is sent between Bob and Alice. In conventional cryptographic systems, this eavesdropping may go undetected, with the result being that any ciphertext sent between Bob and Alice is compromised.

To combat these inherent deficiencies in the key distribution process, researchers have developed a key distribution technique called quantum cryptography. Quantum cryptography employs quantum systems and applicable fundamental principles of physics to ensure the security of distributed keys. Heisenberg's uncertainty principle mandates that any attempt to observe the state of a quantum system will necessarily induce a change in the state of the quantum system. Thus, when very low levels of matter or energy, such as individual photons, are used to distribute keys, the techniques of quantum cryptography permit the key distributor and receiver to determine whether any eavesdropping has occurred during the key distribution. Quantum cryptography, therefore, prevents an eavesdropper, like Eve, from copying or intercepting a key that has been distributed from Alice to Bob without a significant probability of Bob's or Alice's discovery of the eavesdropping.

A well known quantum key distribution scheme involves a quantum channel, through which Alice and Bob send keys using polarized or phase encoded photons, and a public channel, through which Alice and Bob send ordinary messages. Since these polarized or phase encoded photons are employed for QKD, they are often termed QKD photons. The quantum channel is a transmission medium that isolates the QKD photons from interaction with the environment. The public channel may include a channel on any type of communication network such as a Public Switched Telephone network, the Internet, or a wireless network. An eavesdropper, Eve, may attempt to measure the photons on the quantum channel. Such eavesdropping, however, will induce a measurable disturbance in the photons in accordance with the Heisenberg uncertainty principle. Alice and Bob use the public channel to discuss and compare the photons sent through the quantum channel. If, through their discussion and comparison, they determine that there is no evidence of eavesdropping, then the key material distributed via the quantum channel can be considered completely secret.

FIG. 2 illustrates a well-known scheme 200 for quantum key distribution in which the polarization of each photon is used for encoding cryptographic values. To begin the quantum key distribution process, Alice generates random bit values and bases 205 and then encodes the bits as polarization states (e.g., 0°, 45°, 90°, 135°) in sequences of photons sent via the quantum channel 210 (see row 1 of FIG. 3). Alice does not tell anyone the polarization of the photons she has transmitted. Bob receives the photons and measures their polarization along either a rectilinear or diagonal basis with randomly selected and substantially equal probability. Bob records his chosen basis (see row 2 of FIG. 3) and his measurement results (see row 3 of FIG. 3). Bob and Alice discuss 215, via the public channel 220, which basis he has chosen to measure each photon. Bob, however, does not inform Alice of the result of his measurements. Alice tells Bob, via the public channel, whether he has made the measurement along the correct basis (see row 4 of FIG. 3). In a process called “sifting” 225, both Alice and Bob then discard all cases in which Bob has made the measurement along the wrong basis and keep only the ones in which Bob has made the measurement along the correct basis (see row 5 of FIG. 3).

Alice and Bob then estimate 230 whether Eve has eavesdropped upon the key distribution. To do this, Alice and Bob must agree upon a maximum tolerable error rate. Errors can occur due to the intrinsic noise of the quantum channel and eavesdropping attack by a third party. Alice and Bob choose randomly a subset of photons m from the sequence of photons that have been transmitted and measured on the same basis. For each of the m photons, Bob announces publicly his measurement result. Alice informs Bob whether his result is the same as what she had originally sent. They both then compute the error rate of the m photons and, since the measurement results of the m photons have been discussed publicly, the polarization data of the m photons are discarded. If the computed error rate is higher than the agreed upon tolerable error rate (typically no more than about 15%), Alice and Bob infer that substantial eavesdropping has occurred. They then discard the current polarization data and start over with a new sequence of photons. If the error rate is acceptably small, Alice and Bob adopt the remaining polarizations, or some algebraic combination of their values, as secret bits of a shared secret key 235, interpreting horizontal or 45 degree polarized photons as binary 0's and vertical or 135 degree photons as binary 1's (see row 6 of FIG. 3). Conventional error detection and correction processes, such as parity checking or convolutional encoding, may further be performed on the secret bits to correct any bit errors due to the intrinsic noise of the quantum channel.

Alice and Bob may also implement an additional privacy amplification process 240 that reduces the key to a small set of derived bits to reduce Eve's knowledge of the key. If, subsequent to discussion 215 and sifting 225, Alice and Bob adopt n bits as secret bits, the n bits can be compressed using, for example, a hash function. Alice and Bob agree upon a publicly chosen hash function ƒ and take K=ƒ(n bits) as the shared r-bit length key K. The hash function randomly redistributes the n bits such that a small change in bits produces a large change in the hash value. Thus, even if Eve determines a number of bits of the transmitted key through eavesdropping, and also knows the hash function ƒ, she still will be left with very little knowledge regarding the content of the hashed r-bit key K. Alice and Bob may further authenticate the public channel transmissions to prevent a “man-in-the-middle” attack in which Eve masquerades as either Bob or Alice.

### SUMMARY OF THE INVENTION

In accordance with the purpose of the invention as embodied and broadly described herein, a system in a quantum cryptographic key distribution (QKD) receiver may include a circulator, a first mirror, a second mirror, and an optical coupler. The optical coupler may be configured to receive first optical signals from a first port of the circulator, where a first port of the optical coupler couples the received first optical signals to the first mirror and where a second port of the optical coupler couples the received first optical signals to the second mirror.

In another implementation consistent with the present invention, a method of transmitting photon pulses in an optical system may include transmitting a sequence of first photon pulses, where on average each of the first photon pulses includes less than or equal to a threshold number of photons per pulse. The method may further include transmitting a sequence of second photon pulses wherein each of the second photon pulses includes more than the threshold number of photons per pulse, where each of the second photon pulses is delayed a period with respect to a corresponding first photon pulse.

In a further implementation consistent with the present invention, an optical transmitter may include a transmitting unit and a processing unit. The transmitter unit may be configured to transmit multiple optical synchronization pulses at a first intensity, and transmit multiple optical quantum cryptographic key distribution (QKD) pulses at a second intensity, the second intensity being different than the first intensity. The processing unit may be configured to encode a cryptographic key symbol in a quantum state of each QKD pulse of the QKD pulses, and delay transmission of each of the optical synchronization pulses a derived interval after transmission of a corresponding one of the QKD pulses.

### BRIEF DESCRIPTION OF THE DRAWINGS

The accompanying drawings, which are incorporated in and constitute a part of this specification, illustrate exemplary embodiments of the invention and, together with the description, explain the invention. In the drawings,

FIG. 1 illustrates conventional cryptographic key distribution and ciphertext communication;

FIG. 2 illustrates a conventional quantum cryptographic key distribution (QKD) process;

FIG. 3 illustrates conventional quantum cryptographic sifting and error correction;

FIG. 4 illustrates an exemplary network in which systems and methods, consistent with the present invention, may be implemented;

FIG. 5 illustrates an exemplary configuration of a QKD endpoint of FIG. 4 consistent with the present invention;

FIG. 6 illustrates exemplary components of the quantum cryptographic transceiver of FIG. 5 consistent with the present invention;

FIG. 7 illustrates exemplary components of the QKD transmitter of FIG. 6 consistent with the present invention;

FIG. 8 illustrates exemplary components of the QKD receiver of FIG. 6 consistent with the present invention;

FIG. 9 is a diagram illustrating exemplary relationships between bright and dim pulses and framing at the QKD transmitter and receiver;

FIGS. 10A-10C are diagrams that illustrate exemplary symbols used to encode QKD framing information consistent with the present invention;

FIG. 11 is a diagram illustrating an exemplary frame structure consistent with the present invention;

FIGS. 12-13 are flow charts that illustrate an exemplary QKD frame transmission process consistent with the present invention; and

FIGS. 14-15 are flow charts that illustrate an exemplary QKD frame reception process consistent with the present invention.

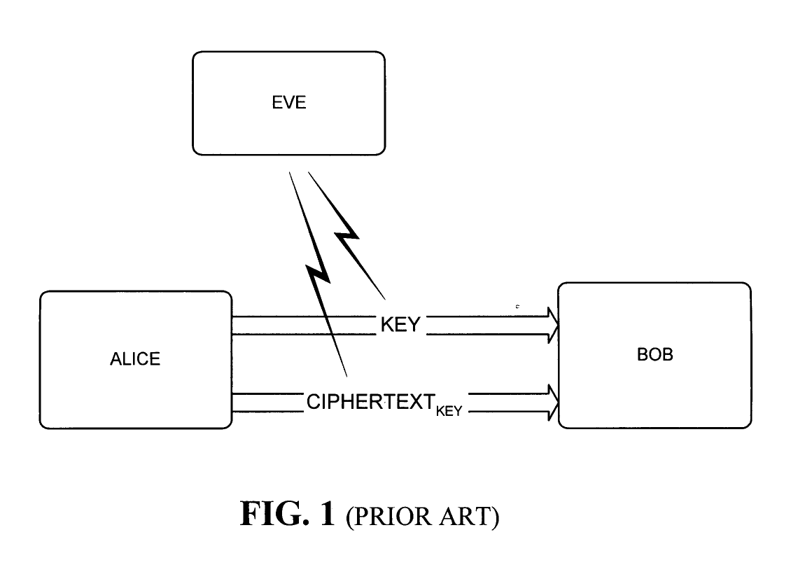

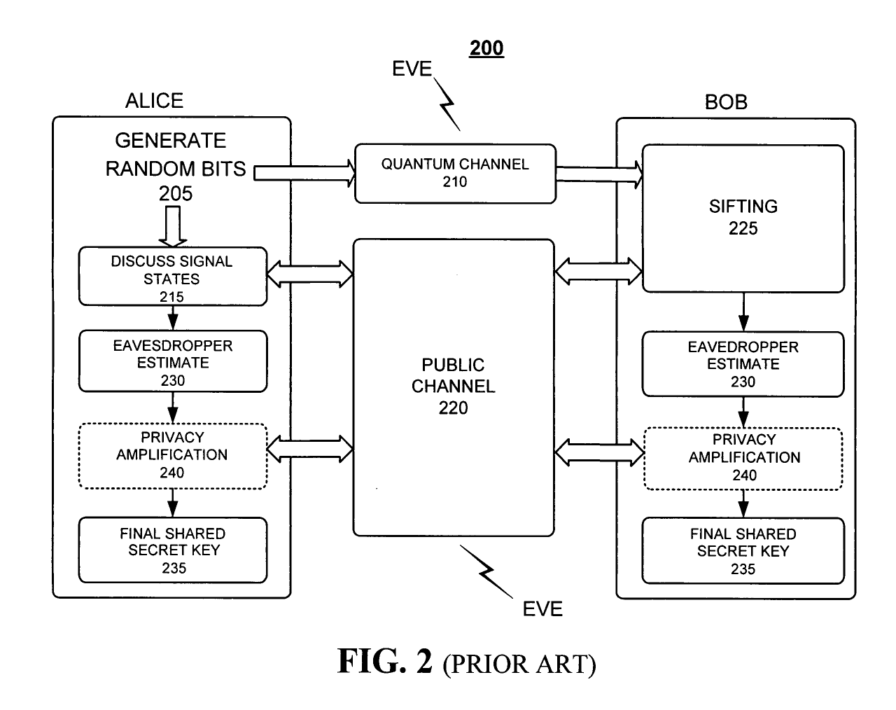

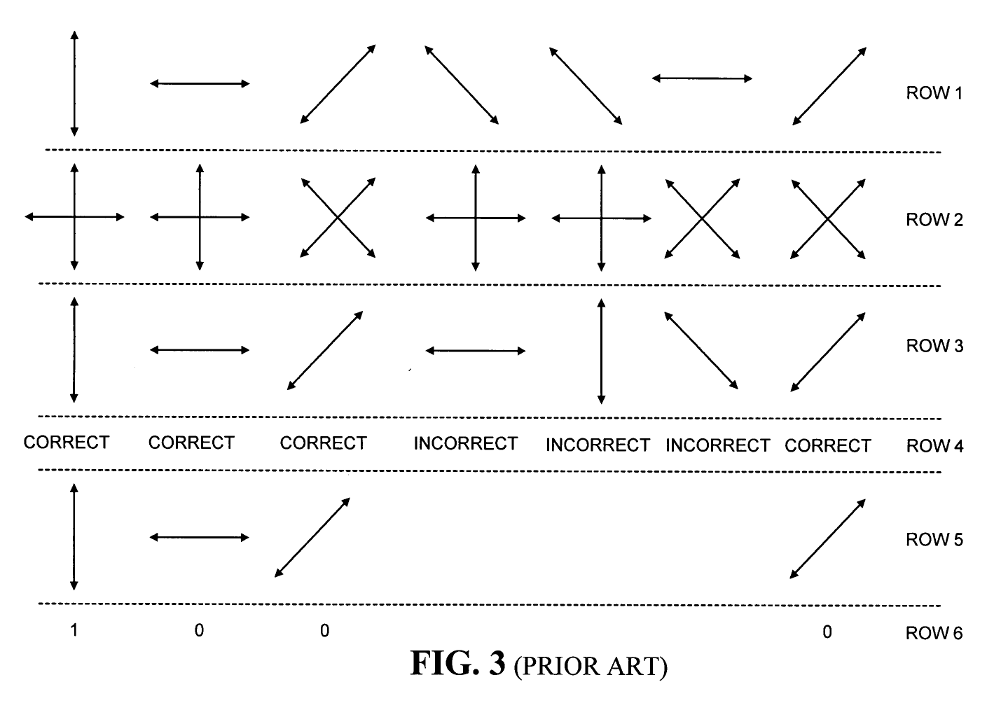

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with the present invention implement framing in quantum cryptographic links through the use of a high intensity (“bright”) optical source, in addition to a nominally single photon (“dim”) optical source used for distributing quantum cryptographic keys, for transmitting synchronization and framing information. Transmission of each bright pulse from the bright optical source may be delayed with respect to each dim pulse transmission from the dim optical source to minimize the effect that each bright pulse may have on the reception of each dim pulse at a receiver. The bright (e.g., multi-photon pulse) optical source may transmit photon pulses that can be used to indicate frame boundaries for the transmitted QKD dim photon pulses. The bright optical source may further transmit photon pulses that indicate a start of frame, a frame sequence number, and a frame length. The frame sequence number may be used, in conjunction with a number assigned to each transmitted single photon pulse, in higher levels of a QKD protocol, such as, for example, in sifting and error correction. Systems and methods consistent with the present invention, therefore, permit the parties to a quantum cryptographic link (i.e., Alice and Bob) to agree on numeric identifiers for QKD photons transmitted between them such that the algorithms of the higher level QKD protocols (e.g., sifting and error correcting) may be more easily employed.

### Exemplary Network

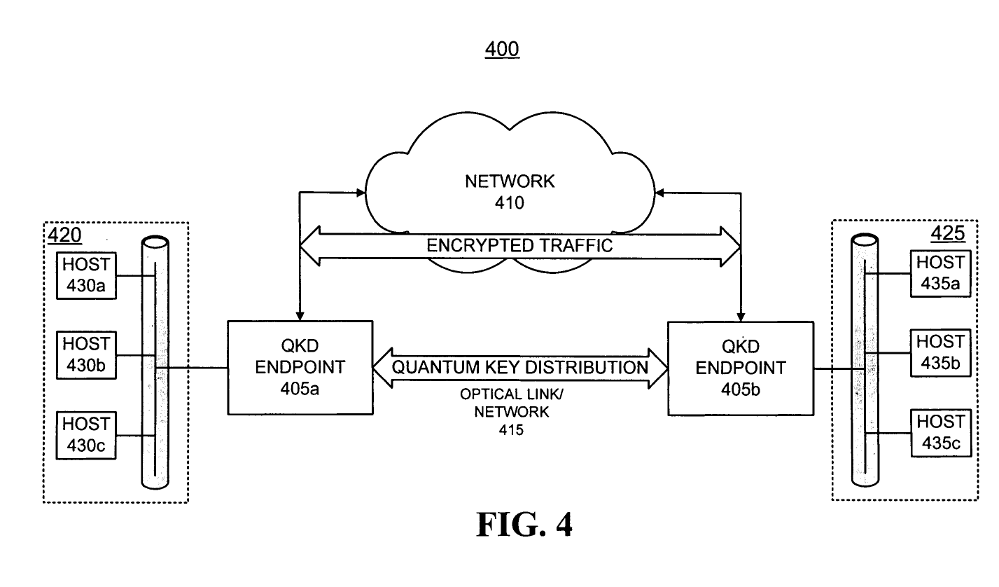

FIG. 4 illustrates an exemplary network 400 in which systems and methods, consistent with principles of the invention, can be implemented that distribute encryption keys via quantum cryptographic mechanisms. Network 400 may include QKD endpoints 405a and 405b connected via a network 410 and an optical link/network 415. QKD endpoints 405a and 405b may each include a host or a server. QKD endpoints 405a and 405b may further connect to local area networks (LANs) 420 or 425. LANs 420 and 425 may further connect with hosts 430a-430c and 435a-435c, respectively. Network 410 can include one or more networks of any type, including a Public Land Mobile Network (PLMN), Public Switched Telephone Network (PSTN), LAN, metropolitan area network (MAN), wide area network (WAN), Internet, or Intranet. Network 410 may also include a dedicated fiber link or a dedicated freespace optical or radio link. The one or more PLMNs may further include packet-switched sub-networks, such as, for example, General Packet Radio Service (GPRS), Cellular Digital Packet Data (CDPD), and Mobile IP sub-networks.

Optical link/network 415 may include a link that may carry light throughout the electromagnetic spectrum, including light in the human visible spectrum and light beyond the human-visible spectrum, such as, for example, infrared or ultraviolet light. The link may include, for example, a conventional optical fiber. Alternatively, the link may include a free-space optical path, such as, for example, a path through the atmosphere or outer space, or even through water or other transparent media. As another alternative, the link may include a hollow optical fiber that may be lined with photonic band-gap material.

Furthermore, optical link/network 415 may include a QKD network that includes one or more QKD switches (not shown) for distributing encryption keys between a source QKD endpoint (e.g., QKD endpoint 405a) and a destination QKD endpoint (e.g., QKD endpoint 405b). Such a QKD network may include the QKD network described in U.S. patent application Ser. No. 09/943,709 (Attorney Docket No. 01-4015), entitled “Systems and Methods for Path Set-up in a Quantum Key Distribution Network,” and U.S. patent application Ser. No. 09/944,328 (Attorney Docket No. 00-4069), entitled “Quantum Cryptographic Key Distribution Networks with Untrusted Switches,” the entire disclosures of which are expressly incorporated by reference herein.

QKD endpoints 405 may distribute Quantum Cryptographic keys via optical link/network 415. Subsequent to quantum key distribution via optical link/network 415, QKD endpoint 405a and QKD endpoint 405b may encrypt traffic using the distributed key(s) and transmit the traffic via network 410.

It will be appreciated that the number of components illustrated in FIG. 4 is provided for explanatory purposes only. A typical network may include more or fewer components that are illustrated in FIG. 4.

### Exemplary QKD Endpoint

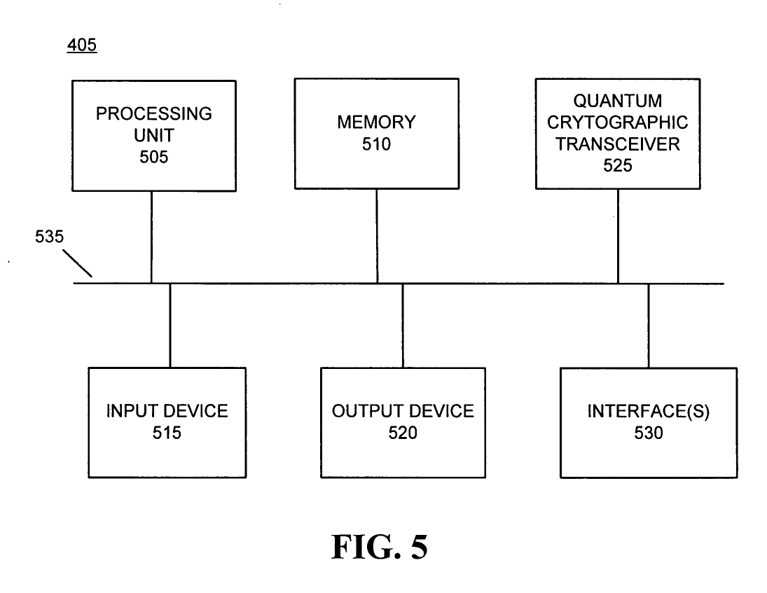

FIG. 5 illustrates exemplary components of a QKD endpoint 405 consistent with the present invention. QKD endpoint 405 may include a processing unit 505, a memory 510, an input device 515, an output device 520, a quantum cryptographic transceiver 525, an interface(s) 530 and a bus 535. Processing unit 505 may perform all data processing functions for inputting, outputting, and processing of QKD endpoint data. Memory 510 may include Random Access Memory (RAM) that provides temporary working storage of data and instructions for use by processing unit 505 in performing processing functions. Memory 510 may additionally include Read Only Memory (ROM) that provides permanent or semi-permanent storage of data and instructions for use by processing unit 505. Memory 510 can also include large-capacity storage devices, such as a magnetic and/or optical recording medium and its corresponding drive.

Input device 515 permits entry of data into QKD endpoint 405 and may include a user interface (not shown). Output device 520 permits the output of data in video, audio, and/or hard copy format. Quantum cryptographic transceiver 525 may include mechanisms for transmitting and receiving encryption keys using quantum cryptographic techniques. Interface(s) 530 may interconnect QKD endpoint 405 with link/network 415. Bus 535 interconnects the various components of QKD endpoint 405 to permit the components to communicate with one another.

### Exemplary Quantum Cryptographic Transceiver

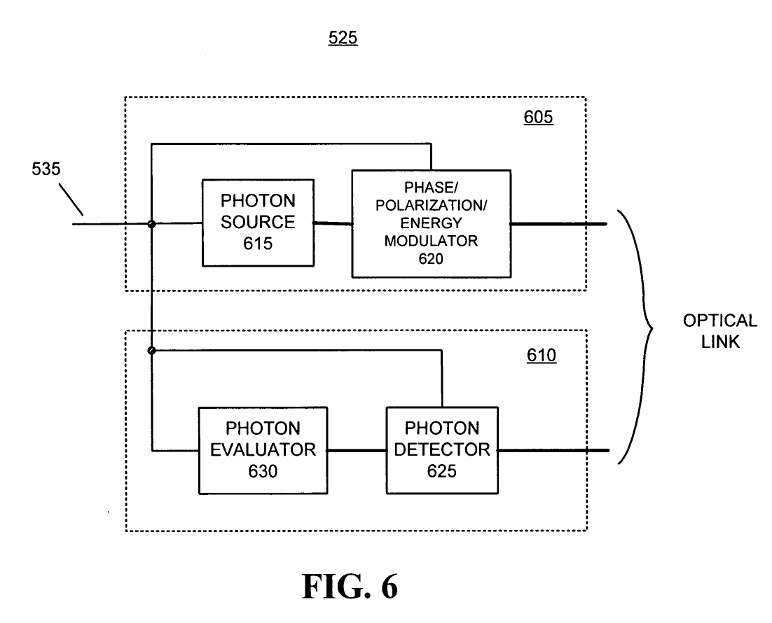

FIG. 6 illustrates exemplary components of quantum cryptographic transceiver 525 of QKD endpoint 405 consistent with the present invention. Quantum cryptographic transceiver 525 may include a QKD transmitter 605 and a QKD receiver 610. QKD transmitter 605 may include a photon source 615 and a phase/polarization/energy modulator 620. Photon source 615 can include, for example, a conventional laser. Photon source 615 may produce photons according to instructions provided by processing unit 505. Photon source 615 may produce photons of light with wavelengths throughout the electromagnetic spectrum, including light in the human visible spectrum and light beyond the human-visible spectrum, such as, for example, infrared or ultraviolet light. Phase/polarization/energy modulator 620 can include, for example, Mach-Zehnder interferometers. Phase/polarization/energy modulator 620 may encode outgoing photons from the photon source according to commands received from processing unit 505 for transmission across an optical link, such as link 415.

QKD receiver 610 may include a photon detector 625 and a photon evaluator 630. Photon detector 625 can include, for example, conventional avalanche photo detectors (APDs) or conventional photo-multiplier tubes (PMTs). Photon detector 625 can also include cryogenically cooled detectors that sense energy via changes in detector temperature or electrical resistivity as photons strike the detector apparatus. Photon detector 625 can detect photons received across the optical link. Photon evaluator 630 can include conventional circuitry for processing and evaluating output signals from photon detector 625 in accordance with quantum cryptographic techniques.

### Exemplary QKD Transmitter

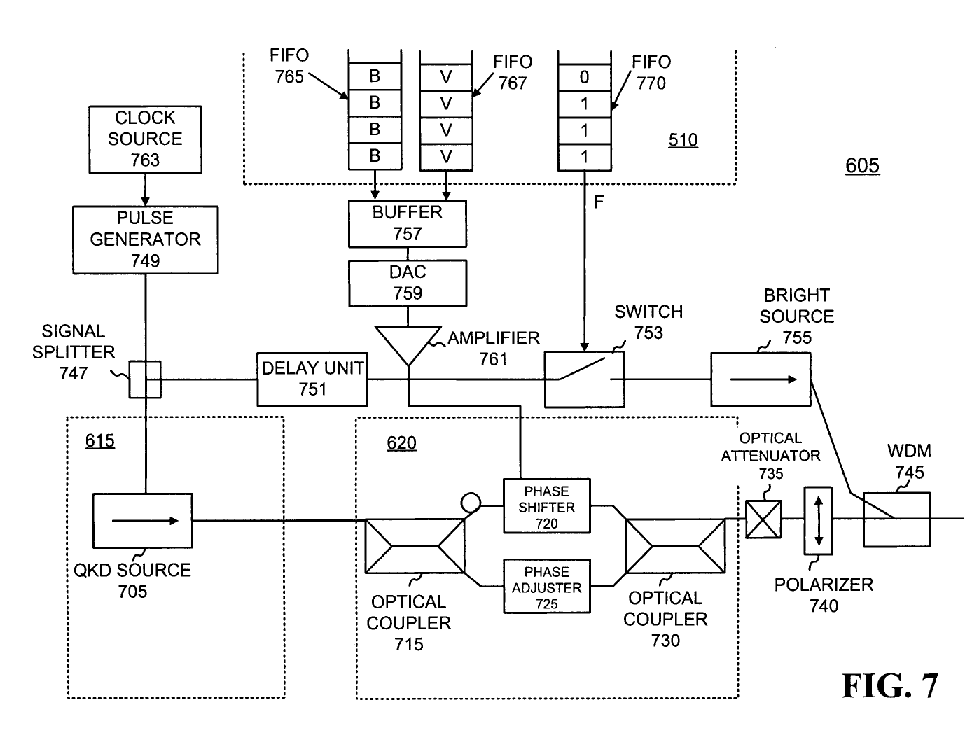

FIG. 7 illustrates exemplary components of QKD transmitter 605 consistent with one aspect of the invention. Photon source 615 of QKD transmitter 605 may include a QKD source 705. Phase modulator 620 of QKD transmitter 605 may include an optical coupler 715, a phase shifter 720, a phase adjuster 725, and an optical coupler 730. QKD transmitter 605 may further include an optical attenuator 735, a polarizer 740, a wavelength division multiplexer (WDM) 745, a signal splitter 747, a pulse generator 749, a delay unit 751, a switch 753, a bright source 755, a buffer 757, a digital-to-analog converter (DAC) 759, an amplifier 761, a clock source 763, and multiple First-in-First-Out (FIFO) queues 765, 767 and 770 of memory 510.

QKD source 705 may include a laser that produces QKD photon pulses (i.e., “dim” photon pulses) at, for example, a wavelength of 1550.12 nm. The number of photons contained in each photon pulse produced by QKD source 705 may be statistically distributed according to, for example, a Poisson distribution. According to such a statistical distribution, a series of photon pulses emitted by QKD source 705, when attenuated by optical attenuator 735, may include less than, or equal to, a threshold level of photons per pulse on average (e.g., on average less than or equal to 1 photon/pulse). Optical coupler 715 may include, for example, a 50/50 coupler, and may couple photon pulses from QKD source 705 to both phase shifter 720 and phase adjuster 725. Phase shifter 720 and phase adjuster 725 may include a Mach-Zehnder interferometer that is modulated to one of four phases to encode both a basis value and a cryptographic key symbol value in each photon's self interference. For example, a cryptographic key symbol of “0” or “1” may be encoded in either of two randomly selected non-orthogonal bases. In one implementation, the “0” key symbol can be encoded by either a phase shift of 0 (basis 0) or π/2 (basis 1) and the “1” key symbol can be encoded by either a π phase shift (basis 0) or a 3π/2 phase shift (basis 1). Four different basis and key symbol pairs (basis, symbol) may, thus, be encoded by four different phase shifts (0, π/2 , π, or 3π/2). This may be achieved by applying four different voltages to phase shifter 720. These voltages may be applied by buffer 757, DAC 759 and amplifier 761, which may convert a basis value B received from FIFO 765 and cryptographic key symbol values V received from FIFO 767 to one of four different voltages for inducing a corresponding phase shift in phase shifter 720. Phase shifter 720 may include an electro-optic modulator that may produce phase shifts in photon pulses received from QKD source 705 in accordance with analog voltages from amplifier 761. Phase adjuster 725 may include an open-air optical path, the length of which may be adjusted to produce a variable optical delay.

Optical coupler 730 may include, for example, a 50/50 coupler, and may couple the signals from phase shifter 720 and phase adjuster 725 to optical attenuator 735. Polarizer 740 may only pass light propagating along one axis of polarization maintaining optical fiber, thus, removing mis-timed replicas of the “dim” pulse from optical attenuator 735 that may have been generated by misaligned polarization maintaining components in the interferometer. WDM 745 may multiplex the “dim” photon pulses from QKD source 705 and attenuator 735 with “bright” photon pulses generated by bright source 755. Bright source 755 may include a laser that produces multi-photon pulses (e.g., “bright” pulses, with each pulse including numerous photons) at, for example, a wavelength of 1550.92 nm.

A series of trigger values may be received from clock source 763 for triggering pulse generator 749. When triggered, pulse generator 749 may send an output electrical pulse that is split, via signal splitter 747, into two identical pulses. One of the pulses from signal splitter 747 may drive QKD source 705, and another of the pulses from signal splitter 747 may pass through delay unit 751 and switch 753 to drive bright source 755. Framing information may be encoded on the clock pulse from clock source 763 by using switch 753 to produce a missing pulse in response to a ‘0’ value on the ‘F’ line from FIFO 770. Delay unit 751 may provide a stable time relationship between “dim” pulses emitted from QKD source 705, via attenuator 735, and “bright” pulses emitted from bright source 755. In one exemplary implementation, the “dim” pulses from QKD source 705 may be timed such that any two “dim” pulses are separated by approximately 17.8 ns, and each “bright” pulse from bright source 755 lags a corresponding “dim” pulse from QKD source 705 by approximately 20.5 ns.

### Exemplary QKD Receiver

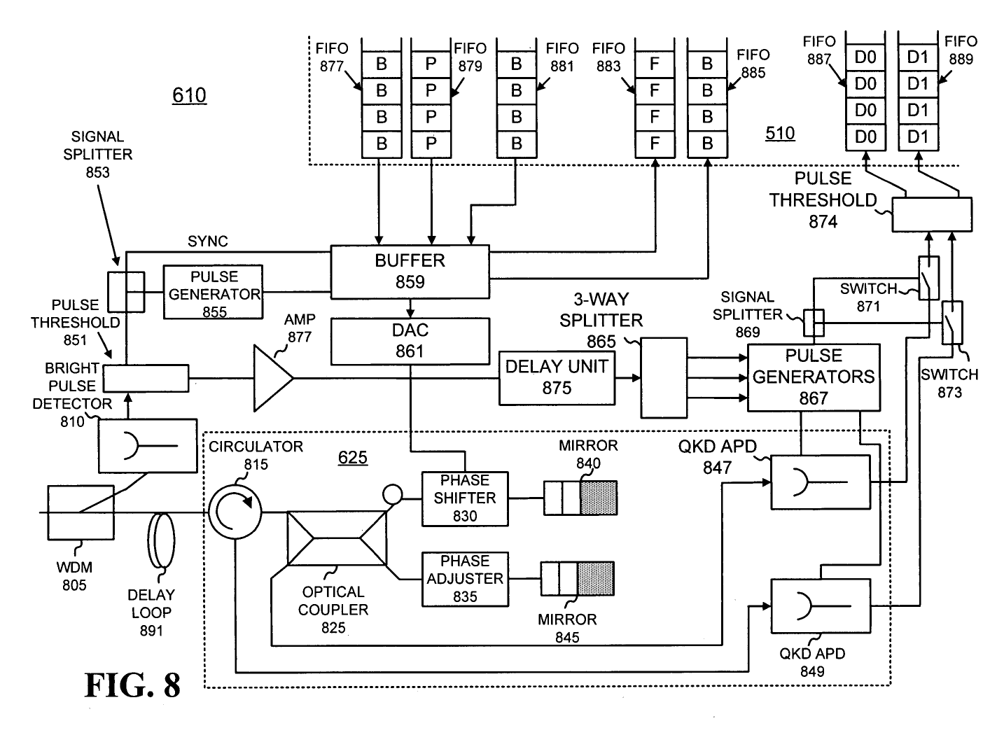

FIG. 8 illustrates exemplary components of a QKD receiver 610 consistent with an aspect of the invention. QKD receiver 610 may include a WDM 805, a bright pulse detector 810, a circulator 815, an optical coupler 825, a phase shifter 830, a phase adjuster 835, mirrors 840 and 845, a QKD APD 847, and a QKD APD 849.

QKD receiver 610 may further include a pulse threshold device 851, a signal splitter 853, a pulse generator 855, a buffer 859, a DAC 861, an amplifier 877, a delay unit 875, a three-way splitter 865, pulse generators 867, a signal splitter 869, switches 871 and 873, a pulse threshold device 874, FIFO queues 877, 879, 881, 883, 885, 887 and 889 of memory 510 and a delay loop 891.

WDM 805 may demultiplex optical pulses transmitted from a QKD transmitter 605 of another QKD endpoint 405. WDM 805 may, for example, demultiplex bright pulses at 1550.92 nm wavelength to bright pulse detector 810. WDM 805 may further, for example, demultiplex dim pulses at 1550.12 nm wavelength to circulator 815 via delay loop 891. Delay loop 891 may delay dim pulses as they pass from WDM 805 to circulator 815, so that the bright pulse corresponding to a given dim pulse may be detected at bright pulse detector 810, and a subsequent gating voltage may be applied by pulse generator 867 to QKD APDs 847 and 849 just prior to the dim pulse arriving at QKD APDs 847 and 849.

Circulator 815 may pass the demultiplexed dim pulses to optical coupler 825. Optical coupler 825 may provide dim pulses from circulator 815 to phase shifter 830 and phase adjuster 835. A basis value (B), clocked out of FIFO 881, may be applied to phase shifter 830 via buffer 859 and DAC 861. The basis value B from FIFO 881 may indicate either a 0-π basis or a π/2-3π/2 basis. FIFOs 877 and 879 may output bits of phase voltage (B-P) for modulating receiver 610's basis and path length control. DAC 861 may translate the basis value B to an output voltage that adjusts the phase shift of phase shifter 830 an amount corresponding to the output voltage. Phase adjuster 835 may include an open-air optical path, the length of which may be adjusted to produce a variable optical delay.

Dim pulses passing through phase shifter 830 may be applied to mirror 840. Mirror 840 may include, for example, a Faraday mirror that reflects incident light such that the polarization of light returning to optical coupler 825 is the same for each arm of optical coupler 825, thus, producing interference with high visibility, irregardless of the polarization of the incoming dim pulse, which may have been set to an arbitrary value by passing through an optical fiber. The dim pulses reflected from mirror 840 may be coupled, via optical coupler 825, to QKD APD 847. Dim pulses passing through phase adjuster 835 may be applied to mirror 845. Mirror 845 may include, for example, a Faraday mirror. The dim pulses reflected from mirror 845 may be coupled, via optical coupler 825 and circulator 815, to QKD APD 849.

Bright pulse detector 810 may pass an electrical annunciator pulse, indicating receipt of a bright photon pulse, to pulse threshold device 851. Pulse threshold device 851 may provide a logic pulse for each bright pulse received at detector 810 to trigger the gating of QKD APDs 847 and 849 via amplifier 877, delay unit 875, three-way splitter 865, and pulse generators 867. Each logic pulse provided by pulse threshold device 851 may be delayed by delay unit 875 and split into three logic pulses by splitter 865. A first logic pulse from splitter 865 may, via one of pulse generators 867, control switches 871 and 873. A second logic pulse from splitter 865 may, via another one of pulse generators 867, control the gating of QKD APD 847. A third logic pulse from splitter 865 may, via a further one of pulse generators 867, control the gating of QKD APD 849.

Delay unit 875 may delay the logic pulse trigger from pulse threshold device 851 a sufficient interval such that QKD APDs 847 and 849 are gated, via switches 871 and 873, precisely at a time a subsequent dim photon pulse arrives. At the receipt of a dim photon pulse at either QKD APD 847 or 849, the outputs of the APDs may be sampled by pulse threshold device 874. Logic high or low symbols corresponding to the output (designated as DO) from QKD APD 847 may be provided to FIFO 887 via pulse threshold device 874. Logic high or low symbols corresponding to the output (designated as D1) from QKD APD 849 may be provided to FIFO 889 via pulse threshold device 874.

Pulse threshold device 851 may further provide a logic pulse, corresponding to each received bright photon pulse, as a trigger to FIFOs 877, 879, 881, 883, 885, 887 and 889. The trigger may “clock” data in or out of each of the FIFOs. Pulse threshold device 851 may also provide a logic pulse, via signal splitter 853, to trigger pulse generator 855. Pulse generator 855, responsive to a trigger pulse from pulse threshold device 851, may pass a framing symbol F to FIFO 883 via buffer 859. This framing symbol F may be accompanied by the basis value B, originally from FIFO 881, which was used to demodulate the accompanying dim pulse, so that the value B may be stored in read-back FIFO 885. This read-back of the B value for a given pulse eliminates the need for timing synchronization between the computer using memory 510 and the opto-electronic subsystem.

### Exemplary QFrame/Photon Pulse Mapping

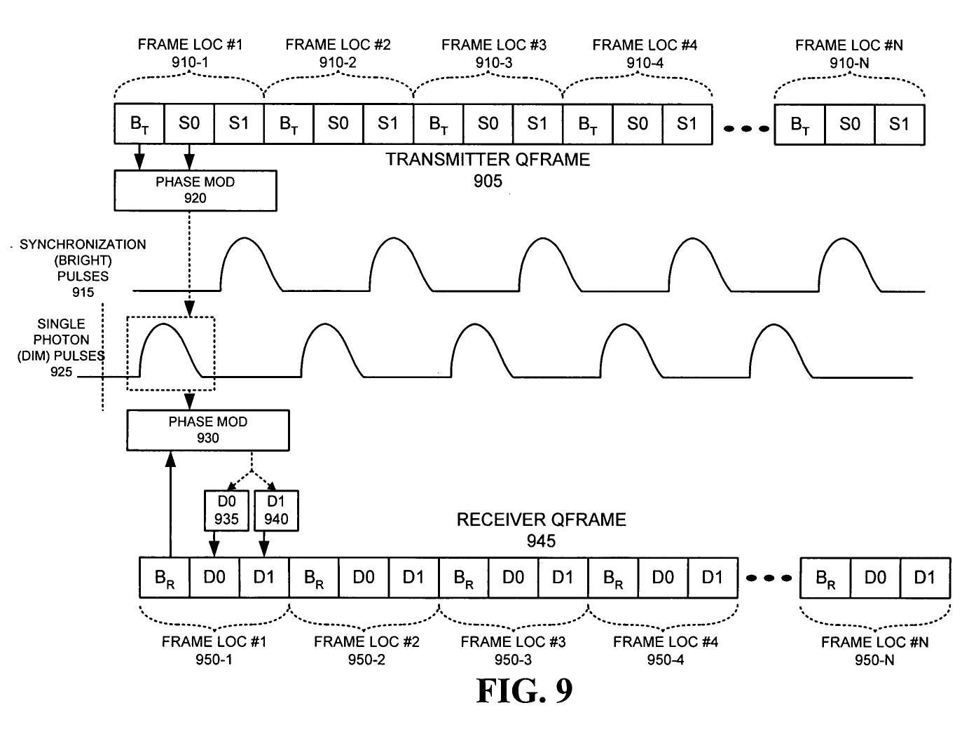

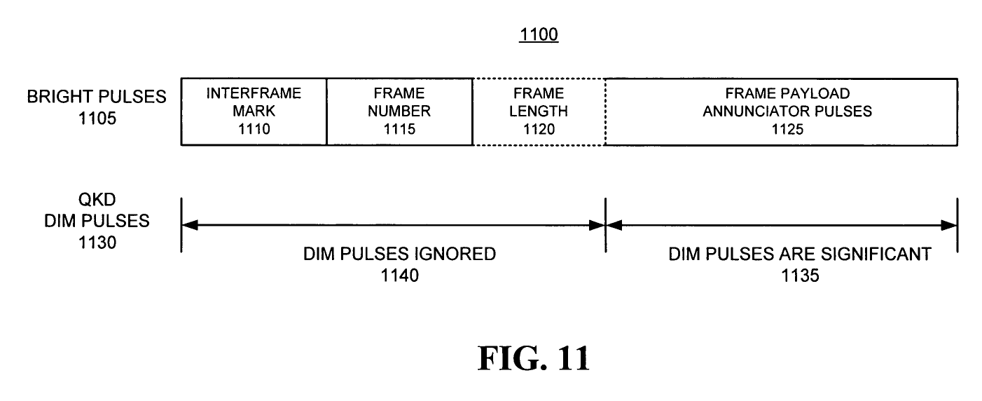

FIG. 9 illustrates an exemplary mapping between a first Qframe 905 constructed at QKD transmitter 605, and a second Qframe 945 constructed at QKD receiver 610, and “bright” and “dim” pulses transmitted by QKD transmitter 605. Bright pulses 915 may indicate synchronization timing and frame boundaries (as described in more detail below with respect to FIG. 11). Dim pulses 925 may contain quantum cryptographic key symbols encoded via modulation of, for example, the phase of the dim photon pulse transmitted from QKD transmitter 605. As shown in FIG. 9, transmission of each bright pulse 915 may be delayed with respect to each dim pulse 925 to minimize the effect that each bright pulse 915 may have on the reception of each dim pulse 925. Therefore, whatever light that “spills over” from the bright pulse channel into the dim pulse detector, e.g., due to imperfections in WDM 805, should “hit” the QKD APDs after the dim pulse, rather than before it, thus diminishing the chance of stray light “confusing” the dim pulse detection. Delay of each bright pulse 915 with respect to each dim pulse 925 also allows the bright and dim pulses to operate at very close frequencies, thus minimizing any timing drift between the pulses caused by frequency-dependent velocity differences through the optical fiber. In one exemplary implementation, each “bright” pulse 915 may lag a corresponding “dim” pulse 925 by approximately 20.5 ns.

A transmitter Qframe 905 may include multiple frame locations (frame loc #1 910-1 through frame loc # N 910-N), each of which may include a number of symbol values. A frame length may determine the number of frame locations in transmitter Qframe 905. The frame length may be fixed, or may vary with each frame. The symbols of each frame location may include a basis symbol B_{T}, a first symbol S0 and a second symbol S1. Basis value B_{T} may indicate one of two bases. A first basis may include a phase shift of 0 or π. A second basis may include a phase shift of π/2 or 3π/2. Symbols S0 and S1 may, together, indicate a quantum cryptographic key symbol. For example, S0 and S1 symbols of “01” may indicate a key symbol of “0.” As an additional example, S0 and S1 symbols of “10” may indicate a key symbol of “1.” Basis symbol B_{T} and each symbol S0 and S1 may be used to phase modulate 920 an outgoing “dim” pulse 925 from QKD transmitter 605.

A receiver Qframe 945 may include multiple frame locations (frame loc #1 950-1 through frame loc # N 950-N), each of which may include a number of symbol values. A frame length may determine the number of frame locations in receiver Qframe 945. The frame length may be fixed, or may vary with each frame. The symbols of each frame location may include a basis symbol B_{R}, a first detected symbol D0 935 and a second detected symbol D1 940. Basis value BR may indicate one of two bases. A first basis may include a phase shift of 0 or π. A second basis may include a phase shift of π/2 or 3π/2. Basis value B_{R} may be used to phase modulate 930 a received dim pulse 925. D0 935 may indicate a symbol detected at QKD APD 847 of QKD receiver 610. D1 940 may indicate a symbol detected at QKD APD 849 of QKD receiver 610.

### Exemplary Bright Pulse Symbol Encoding

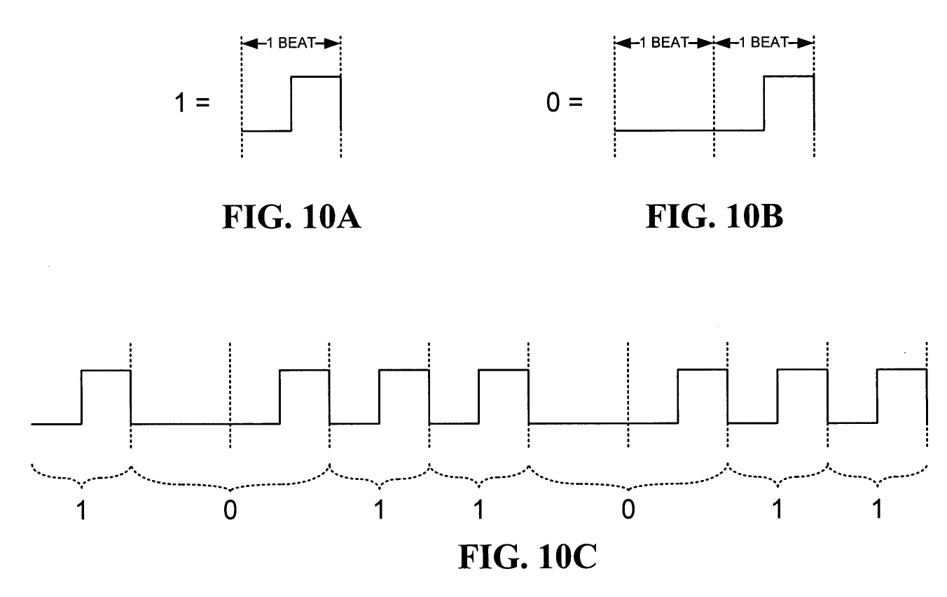

FIGS. 10A-10C illustrate exemplary bright photon pulse symbol encoding consistent with principles of the invention. As shown in FIG. 10A, a “1” symbol can be encoded by a rising edge of a bright photon pulse that is produced within a predetermined “beat” interval. As further shown in FIG. 10B, a “0” symbol can be encoded by a rising edge of a bright photon pulse that is delayed by at least one beat interval. Though FIG. 10B illustrates a rising edge delayed by one beat, the rising edge of the “0” symbol may be delayed an indeterminate period of time, as long as the delay is at least equal to or greater than one beat. For example, a period of a microsecond or more, followed by a rising edge, may indicate a “0” symbol, where a rising edge within a period of time less than that may indicate a “1” symbol. FIG. 10C illustrates an exemplary symbol series “1011011” encoded according to the bright pulse encoding scheme illustrated in FIGS. 10A and 10B.

### Exemplary Bright Pulse Frame Structure

FIG. 11 illustrates an exemplary bright pulse frame 1100 consistent with principles of the invention. Multiple “bright pulses” 1105 transmitted by bright source 755 of QKD source 605 may define frame 1100. Frame 1100 may include an interframe mark 1110, a frame number 1115, an optional frame length 1120 and frame payload annunciator pulses 1125. Interframe mark 1110 may include a specially designated sequence of bright pulses that indicates a start of a new frame. For example, a symbol sequence 00000000001 may indicate a start of a new frame. As an additional example, a symbol sequence 1111111110 may indicate the start of a new frame. Frame number 1115 may include a number of bits that indicate a sequence number of frame 1100. For example, frame number 1115 may include 32 bits binary encoded with frame 1100's frame number.

Optional frame length 1120 may include a number of bits that indicate a frame length of frame 1100. Frame length 1120 may include, for example, 32 bits binary encoded with a length of frame 1100. Frame payload annunciator pulses 1125 may include a number of pulses that identify the boundaries of the payload of frame 1100. In a fixed length frame, frame payload annunciator pulses 1125 may include, for example, 1024 bits all set to “1”. In a variable length frame, for example, frame payload annunciator pulses 1125 may include a number of bits set to “1” as determined by frame length 1120.

During the bright pulses of the frame payload annunciator pulses 1125, the “dim” pulses 1130 transmitted by QKD transmitter 605 can be considered to be “significant”, and, thus, include the symbols of the frame payload (see 1135, FIG. 11). During the period of the frame spanning the interframe mark 1110, frame number 1115 and frame length 1120, any “dim” pulses transmitted by QKD transmitter 605 can be considered insignificant and, thus, ignored (see 1140, FIG. 11).

### Exemplary Quantum Cryptographic Frame Transmission Process

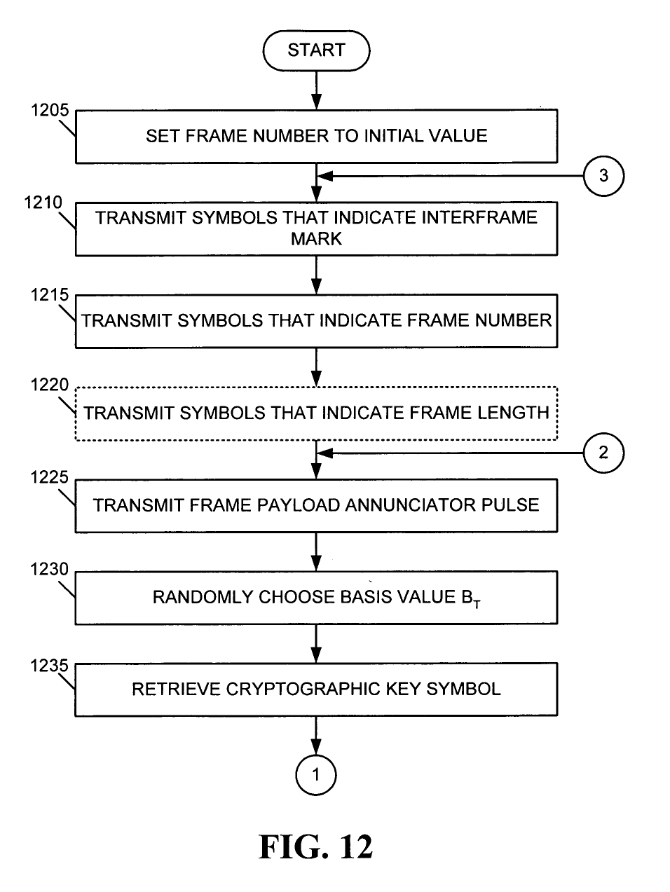

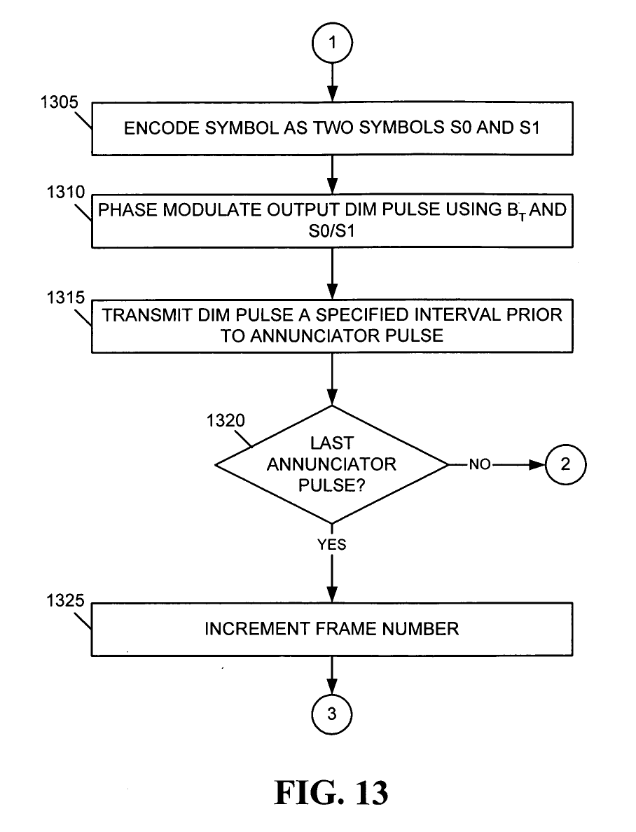

FIGS. 12-13 are flowcharts that illustrate an exemplary process, consistent with the principles of the invention, for framing and transmitting cryptographic key symbols over a quantum cryptographic link. As one skilled in the art will appreciate, the method exemplified by FIGS. 12-13 can be implemented as a sequence of instructions and stored in memory 510 of QKD endpoint 405 for execution by processing unit 505.

The exemplary process may begin with the setting of frame number 1115 to an initial value [act 1205](FIG. 12). In some exemplary embodiments, for example, the frame number can be set to zero. Bright source 755 of QKD transmitter 605 may then transmit symbols that indicate interframe mark 1110 [act 1210]. For example, bright source 755 may transmit the symbols “0000000001” or some other group of symbols to indicate a start of the frame. Bright source 755 of QKD transmitter 605 may further transmit symbols that indicate frame number 1115 [act 1215]. For example, bright source 755 may transmit 32 symbols that include a binary encoded frame number. Bright source 755 may also, optionally, transmit symbols that indicate frame length 1120 [act 1220]. For example, bright source 755 may transmit 32 symbols that include a binary encoded frame length value.

Bright source 755 may transmit a single frame payload annunciator pulse 1125 [act 1225]. This annuniciator pulse may be used for synchronization timing and for setting a frame boundary (e.g., the first annunciator pulse) for the transmitted payload symbols. A basis value B_{T} may be randomly chosen by, for example, processing unit 505 [act 1230]. The basis value B_{T} may indicate whether a cryptographic key symbol will be encoded in a dim photon pulse by phase shifting the pulse along a 0-π basis or a π/2-3π/2 basis. Processing unit 505 may retrieve a cryptographic key symbol [act 1235]. The key symbol may be previously generated according to any convention encryption key generation algorithm and stored in memory 510. Processing unit 505 may then encode the retrieved key symbol as two symbols S0 and S1 [act 1305](FIG. 13). Thus, a “0” key symbol may be encoded as the symbols “01” and a “1” key symbol may be encoded as the symbols “10.” Phase shifter 720 may phase modulate an output dim pulse from QKD source 705 using basis value B_{T} and one of the encoded symbol values S0 and S1 retrieved from FIFO 767 [act 1310]. For example, if transmitting S0 equal to 0, and the basis value B_{T} has been chosen as zero, then the outgoing dim pulse can be encoded with a phase shift of 0. As another example, if transmitting S0 equal to 1, and the basis value B_{T} has been chosen as zero, then the outgoing dim pulse can be encoded with a phase shift of π. QKD source 705 may transmit, via optical attenuator 735, the phase encoded dim photon pulse a specified interval prior to transmission of the frame payload annunciator pulse [act 1315].

Processing unit 505 may determine whether the transmitted frame payload annunciator pulse was the last annunciator pulse of frame payload annunciator pulses 1125 [act 1320]. If not, the exemplary process may return to act 1225 with the transmission of the next frame payload annunciator pulse. If the transmitted frame payload annunciator pulse was the last pulse of the frame, then processing unit 505 may increment frame number 1115 [act 1325 and the exemplary process may return to act 1210 above to begin transmission of the next frame.

### Exemplary Quantum Cryptographic Frame Reception Process

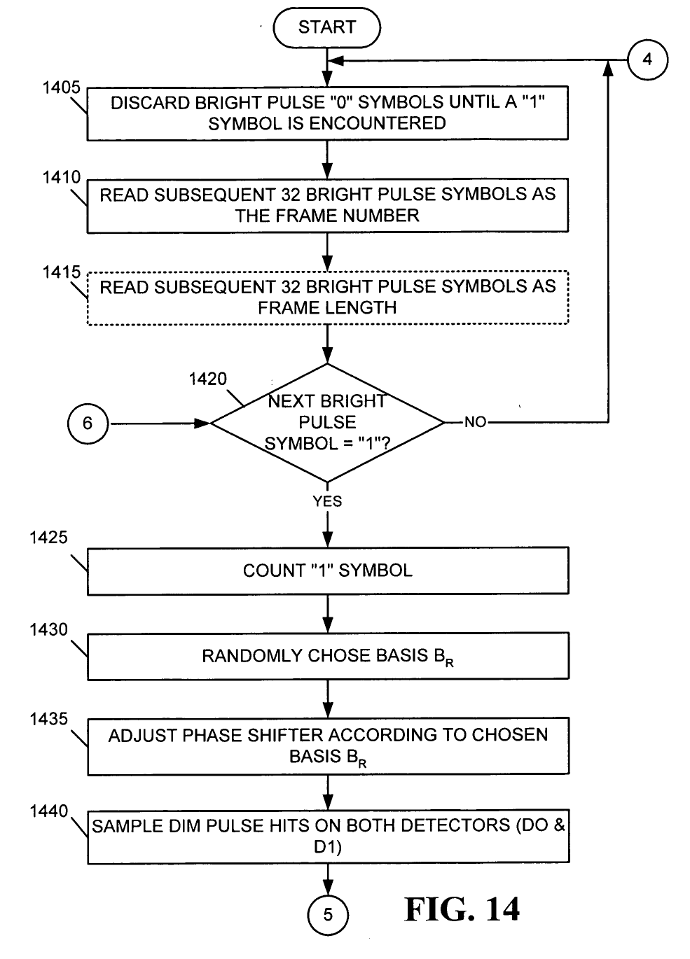

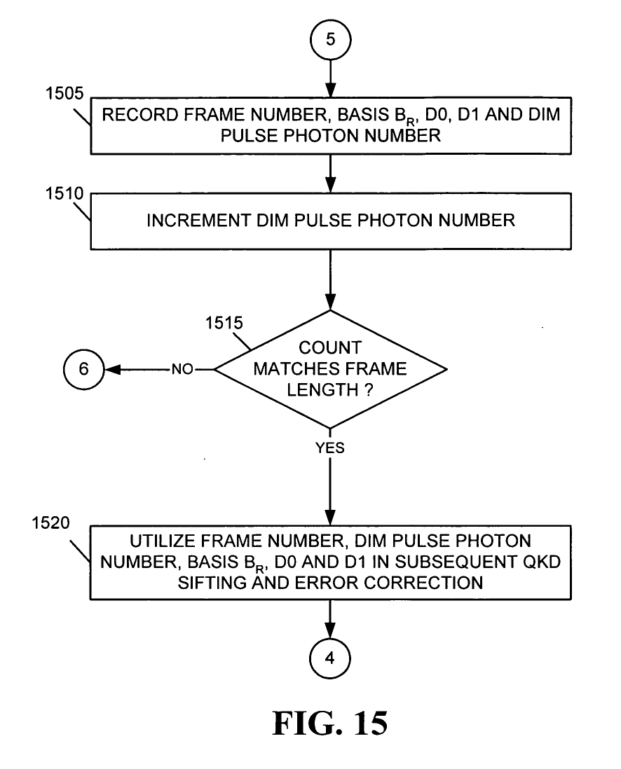

FIGS. 14-15 are flowcharts that illustrate an exemplary process, consistent with the present invention, for receiving and interpreting frames of transmitted cryptographic key symbols. As one skilled in the art will appreciate, the method exemplified by FIGS. 14-15 can be implemented as a sequence of instructions and stored in memory 510 of QKD endpoint 405 for execution by processing unit 505.

The exemplary process may begin with the reception of bright pulses at QKD receiver 610 and the discarding of “0” symbols until a “1” symbol is received at bright pulse detector 810 [act 1405]. The discarded “0” symbols followed by the “1” symbol may indicate interframe mark 1110. Following the “1” symbol, the subsequent 32 symbols may be read as frame number 1115 [act 1410]. The 32 symbols may, for example, include the frame number as a binary encoded value. The symbols following the frame number 1115 may, optionally, be read as frame length 1120 [act 1415]. The frame length symbols may include, for example, 32 symbols that include the frame length encoded as a binary encoded value.

A determination may be made whether the next received bright pulse symbol, following the pulses of frame number 1115 or optional frame length 1120, equals the “1” symbol [act 1420]. If not, then the exemplary process may return to act 1405 above. If the next bright pulse symbol equals the “1” symbol, indicating the start of the frame payload, then the “1” symbol may be counted by, for example, processing unit 505 [act 1425]. Processing unit 505 may randomly choose a basis value BR [act 1430 and may adjust phase shifter 830, via buffer 859 and DAC 861, according to the chosen basis [act 1435]. For example, with a chosen basis value B_{R} of 0, phase shifter 830 may adjust the phase of a received dim pulse by zero degrees. With a chosen basis value B_{R} of 1, for example, phase shifter 830 may adjust the phase of a received dim pulse by π/2 degrees.

Dim pulse hits on both detectors 850 and 860 may then be sampled to produce values D0 and D1 [act 1440]. A current frame number, basis B_{R}, values D0 and D1, and the dim pulse photon number corresponding to the current received dim photon pulse may be recorded in, for example, memory 510 [act 1505]. The dim pulse photon number may then be incremented [act 1510]. A determination may then be made whether the symbol count (act 1425 above) matches the frame length [act 1515]. For example, if the frame length includes 1024 symbols, the end of the frame will occur when the symbol count equals 1024. If the symbol count does not match the frame length, the exemplary process may return to act 1420 for receipt of the next bright annunciator pulse. If the symbol count matches the frame length, then the frame number, dim pulse photon number, basis B_{R}, and D0 and D1 values may be utilized in subsequent QKD sifting and error correction [act 1520]. QKD sifting and error correction may be performed according to existing techniques. The exemplary process may then return to act 1405 to begin the reception of another frame.

### Conclusion

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in hardware and others in software, other configurations may be possible. Furthermore, while wavelength division multiplexing of the bright and dim pulses has been described above, time division multiplexing may be used, alternatively, or in conjunction with wavelength division multiplexing, for transmitting the bright and dim pulses over the quantum cryptographic link (e.g., bright pulses alternating with dim pulses in a time division manner). Additionally, while exemplary embodiments of the present invention have been described as using optical QKD pulses (i.e., photon pulses) for encoding and transmitting cryptographic keys, it will be appreciated that other non-optical pulses that include, for example, individual atoms, electrons, etc., may alternatively be used. In embodiments employing non-optical pulses, the individual quantum particles (e.g., atoms, electrons) may be modulated to encode cryptographic key symbols.

While a series of acts has been described with regard to FIGS. 12-15, the order of the acts may vary in other implementations consistent with the present invention. Also, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

1. A system in a quantum cryptographic key distribution (QKD) receiver, comprising:
a circulator;
a first mirror;
a second mirror; and
an optical coupler configured to receive first optical signals from a first port of the circulator, wherein a first port of the optical coupler couples the received first optical signals to the first mirror and wherein a second port of the optical coupler couples the received first optical signals to the second mirror.

2. The system of claim 1, further comprising:
a first photodetector, wherein the first mirror reflects the received first optical signals back through the first port of the optical coupler and out a third port of the optical coupler to the first photodetector.

3. The system of claim 2, further comprising:
a second photodetector, wherein the second mirror reflects the received first optical signals back through the second port of the optical coupler and the first port of the circulator, and out a second port of the circulator to the second photodetector.

4. The system of claim 1, further comprising:
a wavelength division demultiplexer configured to separate the first optical signals from second optical signals.

5. The system of claim 4, wherein the first optical signals comprise a first wavelength and the second optical signals comprise a second wavelength.

6. The system of claim 5, wherein the first wavelength comprises 1550.92 nm and the second wavelength comprises 1550.12 nm.

7. The system of claim 5, wherein the second optical signals comprise photon pulses having on average less than or equal to a threshold number of photons per pulse and wherein the first optical signals comprise photon pulses having more than the threshold number of photons per pulse.

8. The system of claim 7, wherein the threshold number comprises one.

9. The system of claim 1, wherein the first and second mirrors comprise Faraday mirrors.

10. A method of transmitting photon pulses in an optical system, comprising:
transmitting a sequence of first photon pulses, wherein on average each of the first photon pulses includes less than or equal to a threshold number of photons per pulse; and
transmitting a sequence of second photon pulses wherein each of the second photon pulses includes more than the threshold number of photons per pulse, wherein each of the second photon pulses is delayed a period with respect to a corresponding first photon pulse.

11. The method of claim 10, wherein the first photon pulses comprise a first wavelength.

12. The method of claim 11, wherein the second photon pulses comprise a second wavelength.

13. The method of claim 12, wherein the first wavelength comprises 1550.12 nm and wherein the second wavelength comprises 1550.92 nm.

14. The method of claim 10, wherein the threshold number comprises one.

15. An optical transmitter, comprising:
a memory configured to store cryptographic key symbol values; and
one or more optical sources configured to:
transmit a sequence of first photon pulses based on the stored cryptographic key symbol values, wherein, on average, each of the first photon pulses includes less than or equal to a threshold number of photons per pulse, and
transmit a sequence of second photon pulses, wherein each of the second photon pulses includes more than the threshold number of photons per pulse and wherein each of the second photon pulses is delayed with respect to a corresponding first photon pulse.

16. The transmitter of claim 15, wherein the first photon pulses comprise a first wavelength.

17. The transmitter of claim 16, wherein the second photon pulses comprise a second wavelength.

18. The transmitter of claim 17, wherein the first wavelength comprises 1550.12 nm and wherein the second wavelength comprises 1550.92 nm.

19. The transmitter of claim 15, wherein the threshold number comprises one.

20. A computer-readable medium containing instructions for controlling at least one processor to perform a method of transmitting photon pulses in an optical system, the method comprising:
initiating transmission of a sequence of first photon pulses, wherein, on average, each of the first photon pulses includes less than or equal to a threshold number of photons per pulse; and
initiating transmission of a sequence of second photon pulses wherein each of the second photon pulses includes more than the threshold number of photons per pulse, wherein each of the second photon pulses is delayed with respect to a corresponding first photon pulse.

21. An optical transmitter, comprising:
a transmitting unit configured to:
transmit a plurality of optical synchronization pulses at a first intensity, and
transmit a plurality of optical quantum cryptographic key distribution (QKD) pulses at a second intensity, the second intensity being different than the first intensity; and
a processing unit configured to:
encode a cryptographic key symbol in a quantum state of each QKD pulse of the QKD pulses, and
delay transmission of each of the plurality of optical synchronization pulses a derived interval after transmission of a corresponding one of the plurality of QKD pulses.

22. An system, comprising:
means for transmitting a plurality of optical synchronization pulses at a first intensity;
means for transmitting a plurality of optical quantum cryptographic key distribution (QKD) pulses at a second intensity, the second intensity being different than the first intensity;
means for encoding a cryptographic key symbol in a quantum state of each QKD pulse of the QKD pulses; and
means for delaying transmission of each of the plurality of optical synchronization pulses a derived interval after transmission of a corresponding one of the plurality of QKD pulses.

23. A network device, comprising:
an optical receiver comprising:
a circulator,
a first mirror,
a second mirror, and
an optical coupler configured to receive first optical signals from a first port of the circulator, wherein a first port of the optical coupler couples the received first optical signals to the first mirror and wherein a second port of the optical coupler couples the received first optical signals to the second mirror; and
an optical transmitter comprising:
a memory configured to store cryptographic key symbol values, and one or more optical sources configured to:
transmit a sequence of first photon pulses based on the stored cryptographic key symbol values, wherein on average each of the first photon pulses includes less than or equal to a threshold number of photons per pulse, and
transmit a sequence of second photon pulses, wherein each of the second photon pulses includes more than the threshold number of photons per pulse and wherein each of the second photon pulses is delayed with respect to a corresponding first photon pulse.
